(19) United States
(12) Patent Application Publication
(10) Pub. No.: US 2002/0073913 A1
(43) Pub. Date: Jun. 20, 2002

(54) Vehicle horn

(76) Inventor: John Lu, Taiping City (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/736,634

(22) Filed: Dec. 14, 2000

(51) Int. Cl. G10K 1/00

(52) U.S. Cl. 116/148; 116/154; 340/392.2

(57) ABSTRACT

A vehicle horn has a bell having a circular plate formed at a rear end thereof, a vibration sheet mounted on the circular plate and a contact seat mounted on a central portion of the vibration sheet. A roller is rotatable about an axis through the center of the contact seat. A motor has an output axle extending through a rotor, and a flange formed at a front end thereof and engaged with the circular plate of the bell. A vibration seat is mounted on a front end of the output axle and faces the contact seat. The vibration seat has a wave-like surface being composed of a plurality of staggered concavities and convexities, and is engaged with the roller.

### BACKGROUND OF THE INVENTION

1. Field of the Invention

The present invention is related to a vehicle horn, and more particularly to a vehicle horn which can sound like the roar of a ferocious animal such as a tiger or a lion.

2. Description of Related Art

A conventional vehicle horn sounds a blare by introducing air to actuate a vibration plate, however it can play only a monotonous sound. The sound is so harsh that most people do not like it and, although they become aware of a certain need to be warned, they may feel very displeased by the unvarying tone.

Therefore, the invention provides a vehicle horn to mitigate and/or obviate the aforementioned problem.

### SUMMARY OF THE INVENTION

The main objective of the present invention is to provide a vehicle horn which can sound like the roar of a ferocious animal.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a vehicle horn in accordance with the invention;

FIG. 2 is a perspective view of the vehicle horn in accordance with the invention;

FIG. 3 is a cross sectional view of the vehicle horn;

FIG. 4 is an enlarged partial view showing a friction seat and a vibration seat in accordance with the invention;

FIG. 5 is another cross sectional view showing that the vibration seat is adjusted; and

FIG. 6 is an enlarged view showing a rear end of the vehicle horn.

### DETAILED DESCRIPTION OF THE PREFERRED EMBODIMENT

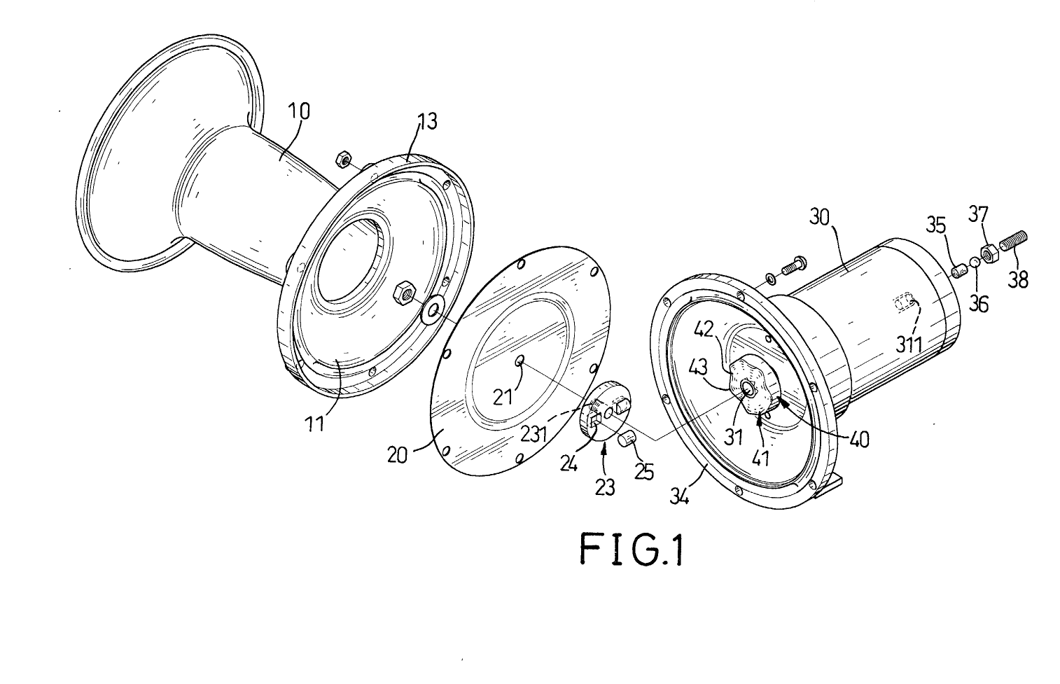

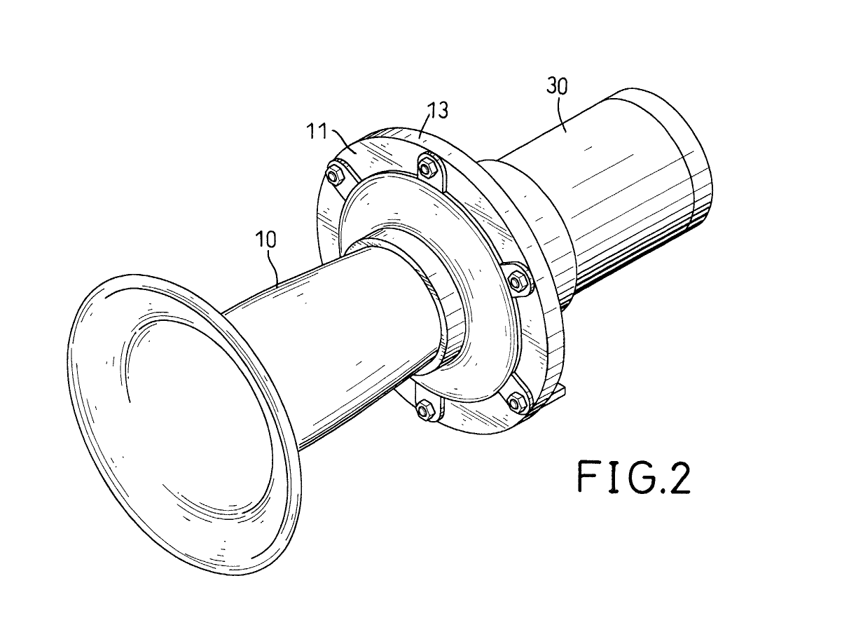

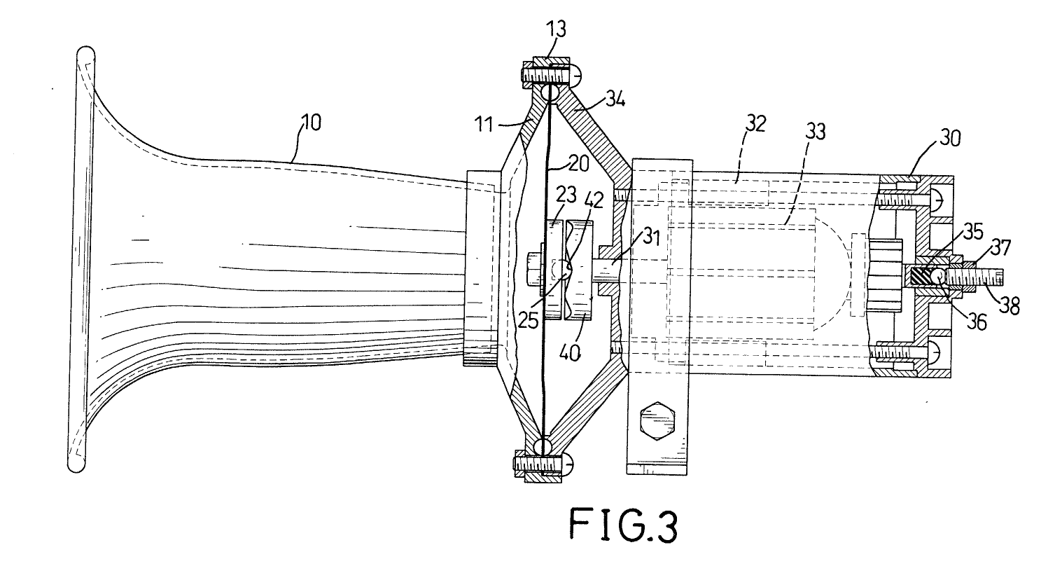

Referring to FIGS. 1-3, a vehicle horn in accordance with the invention is composed of a bell (10), a vibration sheet (20), a motor (30) and a vibration seat (40).

The bell (10) has a circular plate (11) with a rim (13) formed at a rear end thereof. The vibration sheet (20) made of a metal material is provided on the circular plate (11) and has an aperture (21) defined at a central point thereof. A contact seat (23) is mounted on the vibration sheet (20) by a core (231) inserting through the aperture (21). Two openings (24) are diametrically oppositely defined in the contact seat (23), and two rollers (25), which are rotatable about an axis through the center of the contact seat (23), are mounted in the openings (24) respectively.

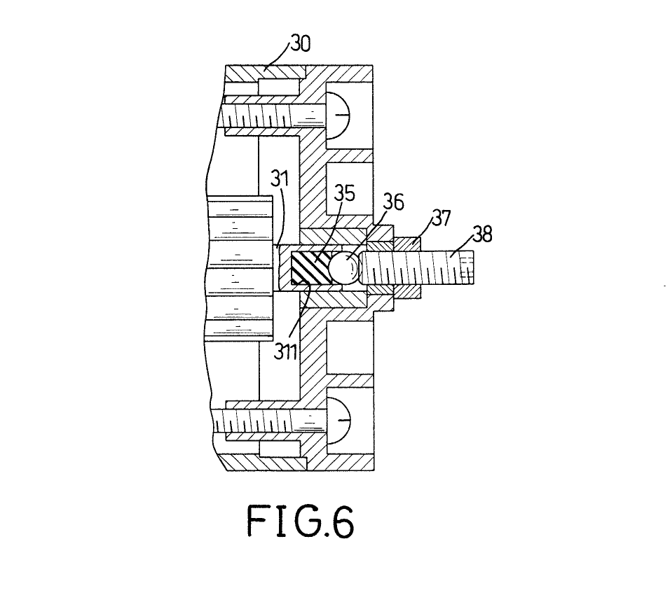

The motor (30) has a stator (32), a rotor (33) and an output axle (31) extending through the rotor (33). A flange (34) is formed at a front end of the motor (30) and engaged with the circular plate (11) of the bell (10) by bolts and nuts (not numbered). The outer periphery of the flange (34) is covered with the rim (13). The output axle (31) has a blind hole (311) defined at a rear end thereof, as shown in FIGS. 1 and 6. A pad (35) and a ball (36) are in turn received in the blind hole (311). A lock nut (37) is provided at the rear end of the output axle (31), and a bolt (38) is engaged in the lock nut (37) and abuts the ball (36) with a distal end thereof. The bolt (38) is adjusted such that the ball (36) pushes against the pad (35), whereby the output axle (31) is urged towards the front end of the motor (30).

The vibration seat (40) is mounted on a front end of the output axle (31) to face the contact seat (23). The vibration seat (40) has a wave-like surface (41), which is composed of a plurality of staggered concavities (42) and convexities (43), tightly abutting the contact seat (23). The concavities (42) are configured to receive the rollers (25) and are complementary to the convexities (43).

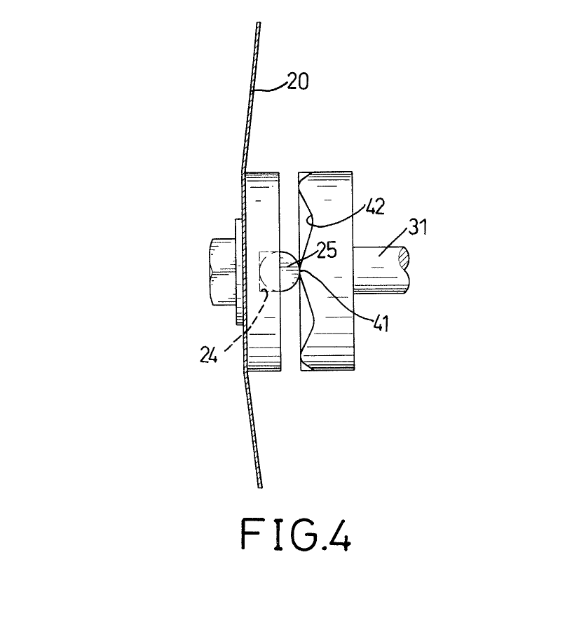

Referring to FIGS. 1, 3 and 4, when the motor is actuated, the output axle (31) and the vibration seat (40) are driven by the rotor (33) to rotate. The vibration seat (40) is urged towards the contact seat (23) whereby the rollers (25) are sandwiched between the vibration seat (40) and the contact seat (23) by the bolt (38) which is in turn held in position by the lock nut (37). The pad (35) enables slight longitudinal movement of the output axle (31), that longitudinal movement being caused by the rollers (25) moving among the convexities (43) and the concavities (42).When the convexities (43) are engaged with the rollers (25), the contact seat (23) is pushed out and the vibration sheet (20) is pressed; when the concavities (42) are engaged with the rollers (25), the contact seat (23) and the vibration sheet (20) return to their original positions. Thus, the vibration sheet (20) vibrates and sounds. The sound is amplified and sent out by the bell (10), whereafter it resembles the roar of a ferociousanimal.

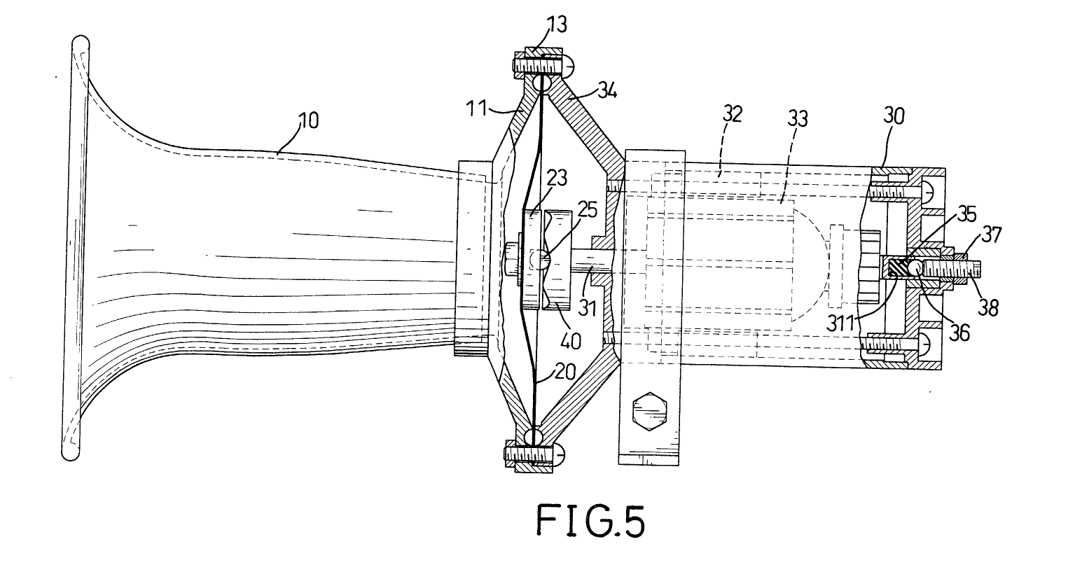

Referring to FIGS. 5 and 6, after long term use of the present horn, the rollers (25) and the wave-like surface (41) will become worn, and an unrequired gap will occur between the rollers (25) and the wave-like surface (41), whereby the sound of the horn will deteriorate. In this case, by loosening the nut (37) from engagement with the motor (30) and then turning the bolt (38) to progress the distal tip thereof towards the vibration sheet (20), the output axle (31) can be pushed forwards to tightly re-engage the wave-like surface (41) with the rollers (25), whereafter the lock nut (37) is re-locked with the motor (30).

The vehicle horn of the present invention has the advantage of producing a very noticeable yet novel sound by which the recipients of the sound will feel pleasantly surprised.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vehicle horn, comprising:
a bell (10) having a circular plate (11) formed at a rear end thereof;
a vibration sheet (20) mounted on the circular plate (11);
a contact seat (23) mounted on a central portion of the vibration sheet (20) and having at least one roller (25) provided thereon, wherein the at least one roller (25) is rotatable about an axis through the center of the contact seat (23);
a motor (30) having an output axle (31) extending through a rotor (33), and a flange (34) formed at a front end thereof and engaged with the circular plate (11) of the bell (10); and
a vibration seat (40) mounted on a front end of the output axle (31) and facing the contact seat (23), the vibration seat (40) having a wave-like surface (41) being composed of a plurality of staggered concavities (42) and convexities (43), and engaged with the at least one roller (25).

2. The vehicle horn as claimed in claim 1, wherein the contact seat (23) has two openings (24) diametrically oppositely defined therein and two rollers (25) are respectively and rotatably provided in the openings (24).

3. The vehicle horn as claimed in claim 1, wherein the concavities (42) are able to receive the at least one roller (25), and the convexities (43) are complementary to the concavities (42).

4. The vehicle horn as claimed in claim 1, wherein the vibration sheet (20) has an aperture (21) defined at a central portion thereof, and the contact seat (23) has a core (231) inserting through the aperture (21) and fastened by fasteners.

5. The vehicle horn as claimed in claim 1, wherein the output axle (31) has a blind hole (311) defined at a rear end thereof, and a pad (35) and a ball (36) are in turn received in the blind hole (311), a lock nut (37) is provided at a rear end of the output axle (31) and clampable against the motor (30), and a bolt (38) is engaged in the lock nut (37) and abuts the ball (36) with a distal end thereof, whereby a gap between the wavelike surface (41) and the contact seat (23) is adjustable to ensure appropriate force on the rollers (25).

6. The vehicle horn as claimed in claim 1, wherein the bell (10) has a rim (13) formed around the circular plate (11).
